(19) United States
(12) Patent Application Publication
(10) Pub. No.: US 2009/0319931 A1
(43) Pub. Date: Dec. 24, 2009

(54) Visual Intelligence Systems

(76) Inventors: Christopher J. Hutchings, Marietta, GA (US); Johans Striedinger, Roswell, GA (US)

Correspondence Address: COURTNEY STANIFORD & GREGORY LLP, 10001 N. De Anza Blvd., Suite 300, Cupertino, CA, 95014, US

(21) Appl. No.: 11/936,611

(22) Filed: Nov. 7, 2007

Related U.S. Application Data
(60) Provisional application No. 60/857,608, filed on Nov. 7, 2006.

(51) Int. Cl. G06F 3/048

(52) U.S. Cl. 715/771; 715/764

(57) ABSTRACT

Whole brain information dashboards or presentations (Information Visualization Dashboards (IVDs)) are described that extract key information elements from complex multi-dimensional data and generate from the extracted elements interactive visual presentations that allow users to explore, analyze, run queries, and rapidly turn data into knowledge and insight using a single presentation or display. Left and right brain views are combined and integrated in a single integrated application and graphical user interface (GUI) at any and all levels of detail. Detailed left brain data is provided in the form of numerical and/or textual information to validate what the user thinks or believes the right brain “big picture” is showing. Along with the integrated views of data, the IVD includes drill-down control over the integrated views as a way of navigating through the data.

### RELATED APPLICATION

This application claims the benefit of U.S. Patent Application No. 60/857,608, filed Nov. 7, 2006.

### TECHNICAL FIELD

The embodiments described herein relate generally to information technology and, more particularly, to systems and methods for information visualization.

### BACKGROUND

The ability to generate information or data has far outstripped the conventional techniques used to organize, analyze and present the data. As a result, people are confronted with exploding volumes of data and have less time to analyze, interpret, and use the data to create value. Conventional or traditional information design and information technology only presents a small percentage of what the data actually means and, consequently, the impact of the data. These conventional information design and presentation formats generally take the form of either linear presentations of data (e.g., tabular presentations) or contextual presentations (e.g., pie chart), but there is no integrated application that allows the user to navigate through data analysis using a single application that presents both formats simultaneously. In order to extract more value from existing data, there is a need for a significantly different approach to information visualization design. Consequently there is a need for information visualization systems that combine and integrate all types of views into data and thus leverage the power of both the analytical side and the contextual side of the brain to see not only the actual data but also the big picture conveyed in the data.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

These and other features, aspects, and advantages of the embodiments described herein will become more readily apparent from the following detailed description, which should be read in conjunction with the accompanying drawings in which:

FIG. 1 is a block diagram of a system that includes the IVD system generating the Information Visualization Dashboards (IVDs), under an embodiment.

FIG. 2 is a flow diagram of a method of displaying data using an IVD system, under an embodiment

FIG. 3 is a first example of an IVD GUI, under an embodiment.

FIG. 4 is a second example of an IVD GUI, under an embodiment.

FIG. 5 is a third example of an IVD GUI, under an embodiment.

FIG. 6 is a fourth example of select portions of an IVD GUI, under an embodiment.

FIG. 7 is a fifth example of select portions of an IVD GUI, under an embodiment.

FIG. 8 is a sixth example of an IVD GUI, under an embodiment.

FIG. 9 is a seventh example of an IVD GUI, under an embodiment.

FIG. 10 is an eighth example of an IVD GUI, under an embodiment.

FIG. 11 is a ninth example of an IVD GUI, under an embodiment.

FIG. 12 is a tenth example of an IVD GUI, under an embodiment.

### DETAILED DESCRIPTION

The systems and methods described herein provide information visualization (IV) in the form of whole brain information dashboards that integrate and leverage the power of both the left and the right side of the brain to see not only the data but also the big picture. The whole brain information dashboards or presentations are referred to herein as Information Visualization Dashboards (IVDs), and the components that function to generate or provide the IVDs are referred to herein as an IVD system, but the description below is not so limited. The IVD system of an embodiment extracts key information elements from complex multi-dimensional data and organizes or generates from the extracted elements appropriate interactive visual presentations that allow users to explore, analyze, run queries, and rapidly turn data into knowledge and insight using a single presentation or display. Left and right brain views are combined and integrated at any and all levels of detail including, for example, the summary level, and the middle levels, and at the detailed level. Detailed left brain data is provided in the form of numerical and/or textual information to validate what the user thinks or believes the right brain “big picture” is showing. The integration of information in both left brain and right brain formats in a single presentation page provides a holistic information delivery system and enables identification of key issues significantly faster (e.g., 400% faster) than conventional presentation formats. Therefore, the time spent analyzing and understanding data can be significantly reduced (e.g., reduced by as much as 80%).

The left hemisphere of the brain, also referred to herein as the left brain, is sequential, logical, and analytical. The left brain participates in the analysis of information and handles logic, sequence, literalness, and analysis. Consequently, humans use their left brains to focus on categories and analyze text, numbers and/or details in an effort to converge on a single quantitative answer. The left brain is particularly good at recognizing serial events, or events whose elements occur one after the other, and controlling sequences of behavior. Serial events or functions include, for example, verbal activities such as talking, understanding the speech of other people, reading, writing, and binary thinking.

In contrast to the left brain, the right hemisphere of the brain, also referred to herein as the right brain, is nonlinear, intuitive, and holistic. Humans use their right brains to focus on relationships between items in an effort to discern the “big picture” of the context of environment associated with or corresponding to the items. The right brain knows about the world and takes care of synthesis, emotional expression, context, and the big picture, and provides humans with the ability to interpret things simultaneously. Thus, the right brain evaluates in a manner that diverges into a “big picture”. The right brain is highly specialized at seeing many things at once. For example, the right brain is specialized in seeing all parts of a geometric shape and grasping its form, or in seeing all elements of a situation and understanding what they mean. The right brain, therefore, confers on humans a significant comparative advantage over computers and machine-based computational systems.

The IVD system and IVD of an embodiment provide a single integrated source of information from multiple data sources, for multi-level, multifunctional user access, at a summary level. Along with the integrated views of data, the IVD system and IVD provide drill-down control over the integrated views as a way of navigating through the database information. In this manner, the IVD provides whole brain information dashboards that integrate and leverage the power of both the left and the right side of the brain to present not only the data but also the big picture in a single integrated application and presentation. The IVD is highly customizable to a particular business or need, is intuitive to use, integrates readily with existing systems and databases, is rapidly installed and deployed, and consequently, provides a rapid and significant analysis capability.

In the following description, numerous specific details are introduced to provide a thorough understanding of, and enabling description for, embodiments of the IVD system and IVD. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

The IVD system is configured and functions to generate or provide an IVD. The IVD system includes a display, and a processor that communicates with the display and executes a display module or component. The processor is coupled to a database or data environment that includes data, where the data includes one or more of structured data and unstructured data. Execution of the display module generates a display page on the display device, the display page including display regions.

Execution of the display module results in generation of an integrated presentation or dashboard. Execution of the display module displays in a first group of the display regions first representations of data present in the data environment. Each of the first representations includes contours, and each contour has a color corresponding to a first attribute of the data. Further, each contour has one of a size and a location corresponding to a second attribute of the data.

Execution of the display module displays in a second group of the display regions second representations of the data. Each of the second representations includes a linear representation. The linear representation includes one or more of a spreadsheet, chart, graph, plot, and list. The second representations are linked to the first representations.

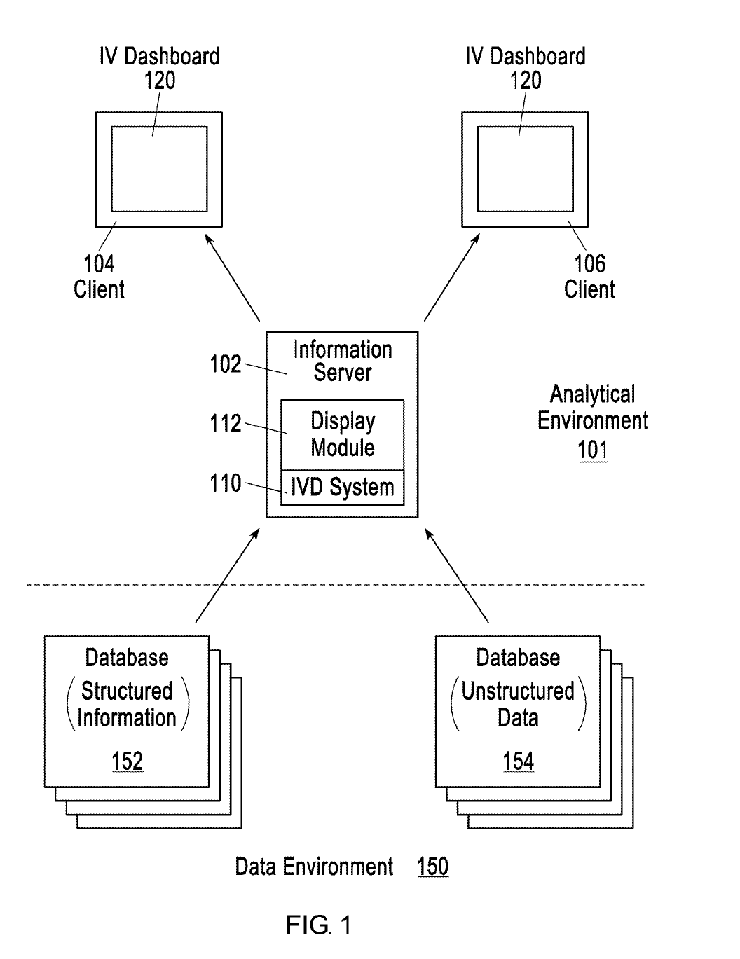

More specifically, FIG. 1 is a block diagram of a system 100 that includes the IVD system 110 generating the Information Visualization Dashboards (IVDs) 120, under an embodiment. The system 100 generally includes a data environment 150 coupled to an analytical environment 101. The data environment 150 includes one or more database(s) 152-154 or other similar and/or disparate sources of data. For example, the database(s) 152-154 can include structured data or information 152 and unstructured data or information 154. Examples of structured data 152 include data organized in or under one or more data structures. Examples of unstructured data 154 include textual information (e.g., electronic documents, electronic forms, electronic mail, etc.). The databases 152-154 of the data environment 150 can be one or more databases which are physically collocated and/or distributed across some number of different locations.

The analytical environment 101 includes one or more information servers 102 coupled to one or more client devices 104-106 and to the database(s) 152-154 of the data environment 150. The information server 102 can include any type and/or combination of processor-based server or computer configured for receiving, processing, and/or transmitting data (e.g., network server, client server, web server, etc.). The information server 102 of an embodiment hosts or runs the display module 112 of the IVD system 110. The client devices 104-106 can include any type and/or combination of processor-based devices (e.g., portable computer (PC), personal digital assistant (PDA), cellular telephone, etc.), including permanent and portable devices. The information server 102 is configured and functions to receive or retrieve data from the database(s) 152-154 and to process the received data for delivery and presentation on the client devices 104-106 via the IVD 120.

The IVD 120 of an embodiment is a graphical user interface that includes a display page on an electronic display. The IVD 120 is generated by the display module 112 running on or under the information server 102, and is provided to client devices 104-106 via a coupling with the client devices 104-106, but is not so limited. The display page includes multiple display regions, and is described in detail below. Each region of a first group of display regions presents data in a right brain format. The data presented in the right brain format includes a display comprising contours that represent attributes of the data. Each contour can have a color corresponding to a first attribute and one of a size and a location corresponding to a second attribute of the data.

A second group of display regions of the page presents data in a left brain format. The data presented in the left brain format includes a linear representation of the data. The linear representation includes, for example, actual text and/or data presented as semantic data, a spreadsheet, chart, and/or matrix to name a few. The data presented on the display in the left brain format is linked to the data presented on the display in the right brain format.

The IVD 120 of an embodiment provides a single integrated source of information from multiple data sources, for multi-level, multifunctional user access, at a summary level, and with controls that allow a user to navigate through various levels of data and apply filters to the various levels of data. The IVD 120 is highly customizable to a particular business or need, is intuitive to use, integrates readily with existing systems and databases, is rapidly installed and deployed, and consequently, provides a rapid and significant analysis capability.

The components of the IVD system 110 can be components of a single system, multiple systems, and/or geographically separate systems. The IVD system components can also be subcomponents or subsystems of a single system, multiple systems, and/or geographically separate systems. The IVD system components can be coupled to one or more other components (not shown) of a host system or a system coupled to the host system.

The IVD system components are configured and function, individually and/or collectively, to provide data products or outputs including the IVD, as described in detail below. The IVD system also includes portals and/or couplings by which users can access data. The portals and/or couplings of an embodiment include, for example, couplings or connections between a user's computer or client device and the IVD system.

The IVD system 110 of an embodiment includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, cellular telephones, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database as described above. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components of the IDSS, and/or provided by some combination of algorithms. The IVD methods described herein can be implemented in one or more of software algorithm(s), programs, firmware, hardware, components, circuitry, in any combination.

The IVD system components can be located together or in separate locations. Communication paths couple the IVD system components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

The IVD system and IVD of an embodiment includes business intelligence applications or software and business process methodologies that combine and integrate applications to leverage the power of the whole brain to present new ways of looking at data. The IVDs deliver innovative integrated presentations that leverage both the left and the right sides of the brain to accelerate understanding, analysis, and fact based decision making associated with large and complex data. As such, the IVDs leverage the concepts of information visualization to provide users with tools to view, understand and extract information from their data assets

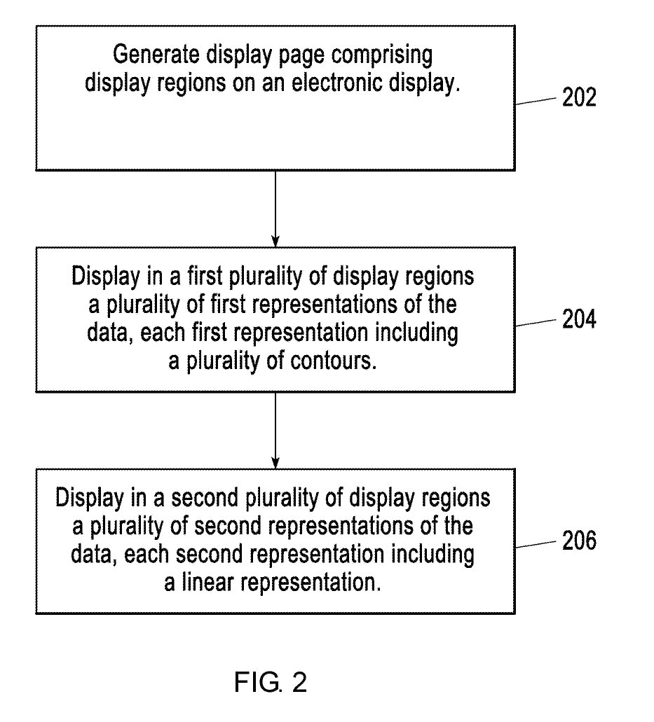

FIG. 2 is a flow diagram of a method of displaying data 200 using an IVD system, under an embodiment. The method of displaying data includes generating 202 a display page on an electronic display, where the display page includes multiple display regions. The electronic display can be a display of a client device or computer, as described above.

The method of displaying data includes displaying 204 in a first group of the display regions a number of first representations of the data. Each of the first representations includes some number of contours. Each contour has a color corresponding to a first attribute of the data. Furthermore, each contour has one of a size and a location corresponding to a second attribute of the data. It is noted that different regions of the first group of display regions can present or include a different type and/or combination of contour.

The method of displaying data includes displaying 206 in a second group of the display regions a number of second representations of the data. Each of the second representations includes a linear representation of the data represented in a corresponding first representation. A linear representation includes but may not be limited to a spreadsheet, chart, matrix, plot, list, and semantic data. It is noted that different regions of the second group of display regions can present or include a different type and/or combination of linear representation. The second representations are linked to the first representations in that both the first and second representations present or represent the same level or hierarchy of data.

The IVDs, as described herein, are highly flexible, real-time digital visualization applications, presentations, or tools that combine linear (left brain) representations (e.g., lists, spreadsheets, graphs) of data, with multiple, dynamic, pictorial (right brain) views (e.g., tree maps, color coded heat maps, country maps, pie charts, etc.) that enable rapid identification of problems, variances, and trends in the represented data. The IVDs thus provide a complete picture of and control in analyzing relevant information. Unstructured data such as semantic information (variance narratives, emails, etc.) can be integrated with structured financial or performance data displayed in the IVD so the “complete story” is readily available at the click of a mouse. Consequently, the IVDs provide a single source of information from multiple data sources, for multi-level, multifunctional user access, with minimal training, at a summary level, and with drill-down detail available at the click of a mouse.

The IVD of an embodiment includes a graphical user interface (GUI). A GUI is generally a type of user interface which allows people to interact with a computer and computer-controlled devices which employ graphical icons, visual indicators or special graphical elements, along with text, labels or text navigation to represent the information and actions available to a user. The actions are usually performed through direct manipulation of the graphical elements.

The GUI of an embodiment includes a display page on an electronic display. The display page comprises multiple display regions. The GUI includes a group of first representations of data displayed in a first group of the display regions of the display. The first representations of an embodiment are right brain information, but are not so limited. Each of the first representations includes some number of contours. Each contour has a color corresponding to a first attribute of the data. Furthermore, each contour has one of a size and a location corresponding to a second attribute of the data. It is noted that different regions of the first group of display regions can present or include a different type and/or combination of contour.

The GUI includes a number of second representations of the data displayed in a second group of display regions. The first representations of an embodiment are left brain information, but are not so limited. Each of the second representations includes a linear representation of the data represented in a corresponding first representation. A linear representation includes but may not be limited to a spreadsheet, chart, matrix, plot, list, and semantic data. It is noted that different regions of the second group of display regions can present or include a different type and/or combination of linear representation. The second representations are linked to the first representations in that both the first and second representations present or represent the same level or hierarchy of data.

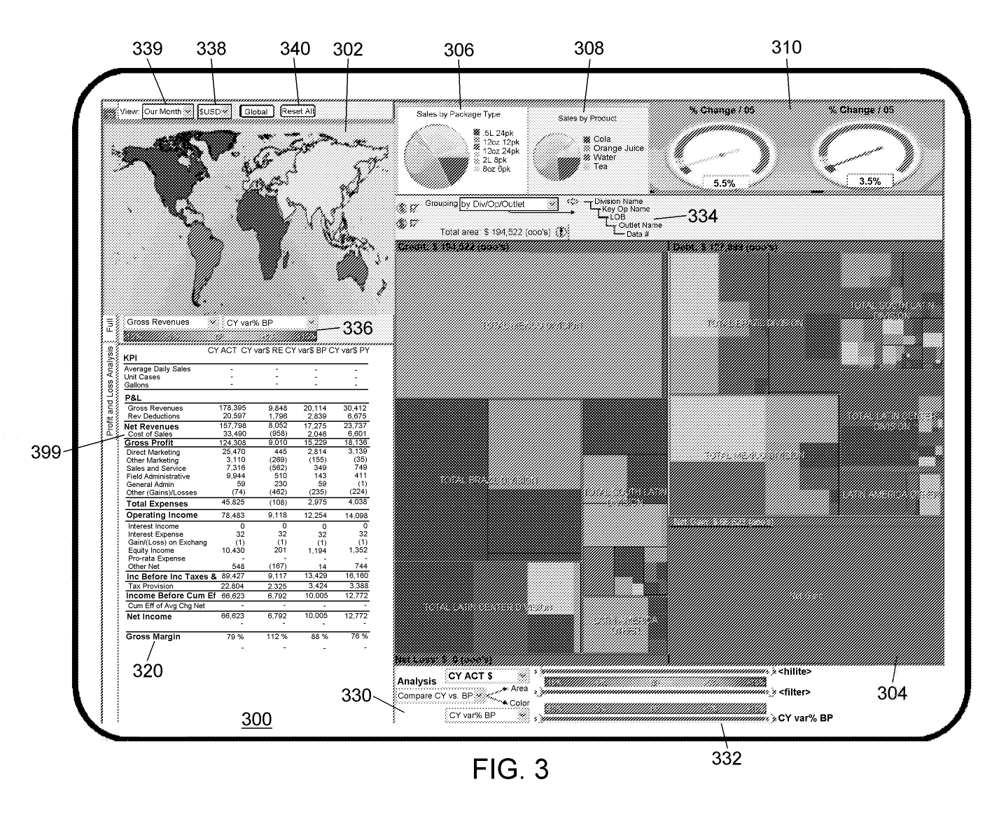

FIGS. 3-10 show numerous examples of presentation or display pages of the IVD GUI of an embodiment. These presentation samples are presented only as examples of the various types and/or combinations of left brain and right brain information, and the corresponding controls, which are integrated and presented using the IVD system and IVD of an embodiment. However, it is noted that the IVD is not limited to only the presentations shown in the figures described below.

FIG. 3 is a first example of an IVD GUI 300, under an embodiment. The GUI 300, as described above, includes multiple display regions. The GUI 300 includes first representations 302-310, or right brain representations 302-310, of data displayed in a first group or set of regions of the display. The GUI 300 also includes second representations 320, or left brain representations 320, of data displayed in a second group or set of regions of the display. The second representations 320 are integrated into the same display or application as the first representations 302-310. The data supporting the right brain 302-310 and left brain 320 representations is the same data. The GUI 300 further includes a third group or set of regions of the display that include controls 330-340. The controls 330-340 provide varying types and combinations of control over the right brain 302-310 and left brain 320 representations, as described in detail herein.

Each of the right brain representations 302-310 includes some number of contours. Each contour has a color corresponding to a first attribute of the data. For example, one region or area of the GUI 300 includes a right brain representation that includes a Geo-Map 302 presenting high-level information in the context of selected geography. The different geographical regions of the world are contours, and each contour has a color corresponding to a data attribute of that geographical region. For example, North America can be displayed using a first color while South America can be displayed using a second color different from the first. The location of the geographical region represents a second attribute of the data.

Another region or area of the GUI 300 includes a right brain representation that includes a tree map 304 that shows multiple dimensions of information in a single “big picture”. The tree map 304 depicts detail items as a rectangle having size and color representing a different data attribute. For example, the size of each rectangle can represent dollar sales, units sold, credit or debit items in a profit and loss account, or customer balances to name a few. The color of each rectangle can represent percentage variances, performance issues (for example, sales performance percentage growth versus budget or prior year), percentage defects, percentage out of stocks, or other data attributes to name a few (e.g., red indicates undesirable, yellow indicates caution and green indicates a desired outcome, etc.). Furthermore, each contour has one of a size and a location corresponding to a second attribute of the data. It is noted that different regions of the first group of display regions can present or include a different type and/or combination of contour. In this example the user has selected South America via the Geo-Map 302, which results in the presentation of data for South America in the tree map 304.

The color coding standard of the geographical map 302 can have the same meaning as the color coding standard of the tree map 304 in an embodiment. For example, the color coding can range from green (favorable) though yellow (caution) to red (unfavorable) for whatever selection criterion is selected (e.g., actual sales performance versus budget). The selector keys 336 and 332 allow the user to elect the range of the variance from +100% to −100%. Each country in the geographical map display 302 will have the same color and relevant intensity as income statement items selected in the tree map 304 based on the performance of the specific country or income statement line item selected against the budget.

As yet another example, the right brain representation can include one or more pie charts 306-308 where, in this example, pie charts showing differing data attributes (e.g., Sales by Package Type, Sales by Product) are presented. The right brain representation can further include or present one or more meters or meter-type charts 310 showing differing data attributes.

The left brain representations 320 of the GUI include a statement or chart that includes actual numerical data along with textual descriptions of the data presented. The numerical and textual information presented in the left brain representation 320 corresponds to the right brain representations 302-310. While a chart is presented in this example GUI 300, the embodiment is not limited to a chart and can include any presentation type and/or combination (e.g., spreadsheet, matrix, plot list, etc.) that includes numerical and/or textual data.

Additional regions of the GUI 300 include one or more controls 330-340 linked to the data in such a manner as to provide a user the ability to navigate through the data or manipulate the right and left brain representations of the GUI 300. The controls can include drop-down menus 330, 334, 336, 338, sliders 332, and buttons 340 and/or any other type of control device or icon as appropriate to an electronic presentation and the configuration of the GUI 300. Further, the controls 330-340 can be configured to allow a user to select one or more particular dashboard views so that the screen real estate is filled with only that specific view/representation of the data, be it left brained or right brained. This selection allows the user to further focus his/her attention on that view as a source for further analysis and drill down.

Generally, the controls can provide control over selection of the data so that a selection made via the controls is reflected in the right and left brain representations of the GUI. For example, the controls can provide control over selection of a level or hierarchy of the data 334. In another control example, the controls can provide control over selection of data for a particular time period 339. The time period can be one of a historical time period and/or a future time period. Additionally, the controls can provide control over selection of dynamic queries of the data. The controls can also provide control over selection of dynamic queries that highlight selected data entities of the data. As yet another example, the controls can provide control over selection of dynamic queries that filter the data. In a further example, the controls can provide control over selection of content, data type, graphic type, and/or data level. The controls can also be used to select or filter data to a manageable number for inclusion in reports which can be exported into standard formats (e.g. Excel) to facilitate the follow up of a limited number of selected items.

In addition to separate controls provided in dedicated regions of the GUI 300, the contours of the right brain representations 302-310 can also serve as controls that provide control over selection of the data so that a selection made via a right brain representation or contour (e.g., clicking on a contour, positioning a mouse or cursor over a contour, etc.) is reflected in the right and left brain representations of the GUI. As one example, selecting or clicking South America in the Geo-Map 302 results in display of data for the regions of South America in the tree map 304 and the other representations of the GUI 300, as described above.

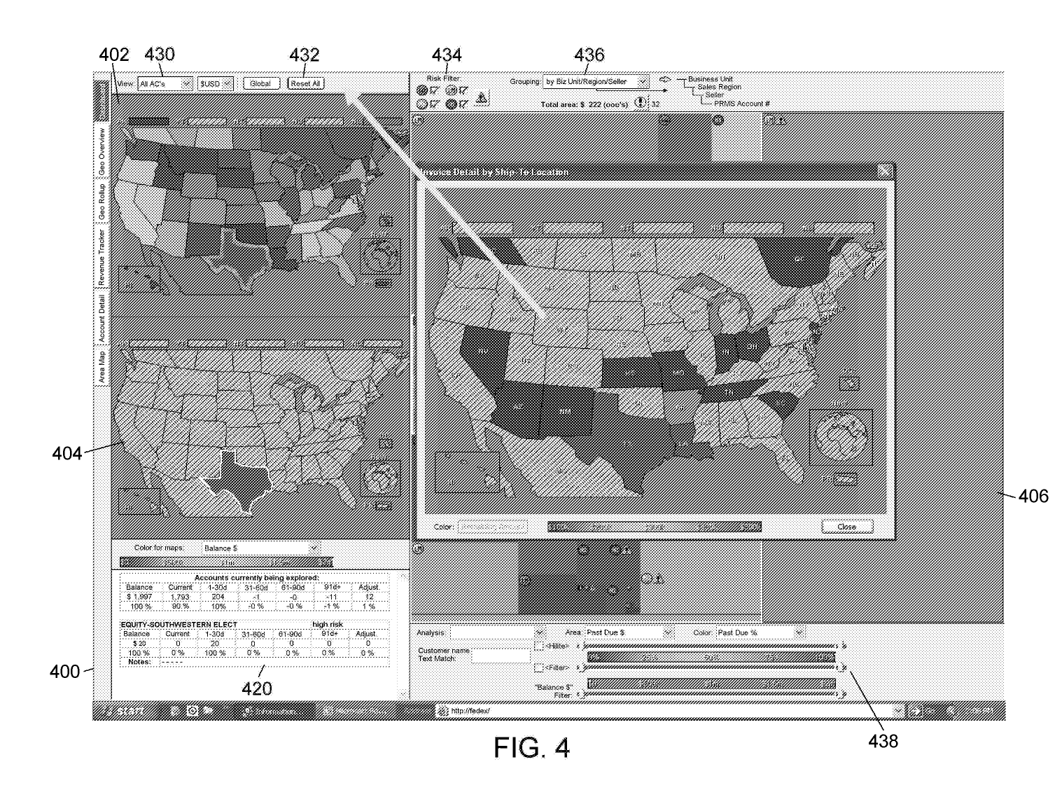

FIG. 4 is a second example of an IVD GUI 400, under an embodiment. The GUI 400 includes multiple display regions. The GUI 400 includes right brain representations 402-406 of data displayed in a first group or set of regions of the display. The GUI 400 also includes left brain representations 420 of data displayed in a second group or set of regions of the display. The second representations 420 are integrated into the same display or application as the first representations 402-406. The data supporting the right brain 402-406 and left brain 420 representations is the same data and is linked via the GUI 400. The GUI 400 further includes a third group or set of regions of the display that include controls 430-438. The controls 430-438 provide varying types and combinations of control over the right brain 402-406 and left brain 420 representations. The controls 430-438 can be configured to allow a user to select one or more particular dashboard views so that the screen real estate is filled with only that specific view/representation of the data, be it left brained or right brained. This selection allows the user to further focus his/her attention on that view as a source for further analysis and drill down.

More specifically, GUI 400 includes a Geo-Map 402 of the United States (US) by which a user has selected presentation of data relating to the state of Texas. The Geo-Map 402 is therefore presenting summary information or averages of an attribute of the data (e.g., BILL-TO Account data) for each state with related links to other accounts in other states connected with Texas. This is an example in which the contours of the right brain representations can also serve as controls that provide control over selection of the data so that a selection made via a right brain representation or contour (e.g., clicking on a contour, positioning a mouse or cursor over a contour, etc.) is reflected in the right and left brain representations of the GUI. In this example, selecting or clicking Texas in the Geo-Map 404 (right brain representation) results in the display in the tree map 406 of BILL-TO Account data for regions in Texas, and the display of a pop-up Geo Map 408 showing SHIP-TO Accounts in other states outside Texas.

The left brain representations 420 of the GUI 400 include a statement or chart that includes actual numerical data along with textual descriptions of the data presented. While a chart is presented in this example GUI 400, the embodiment is not limited to a chart and can include any presentation type and/or combination (e.g., spreadsheet, matrix, plot list, etc.) that includes numerical and/or textual data.

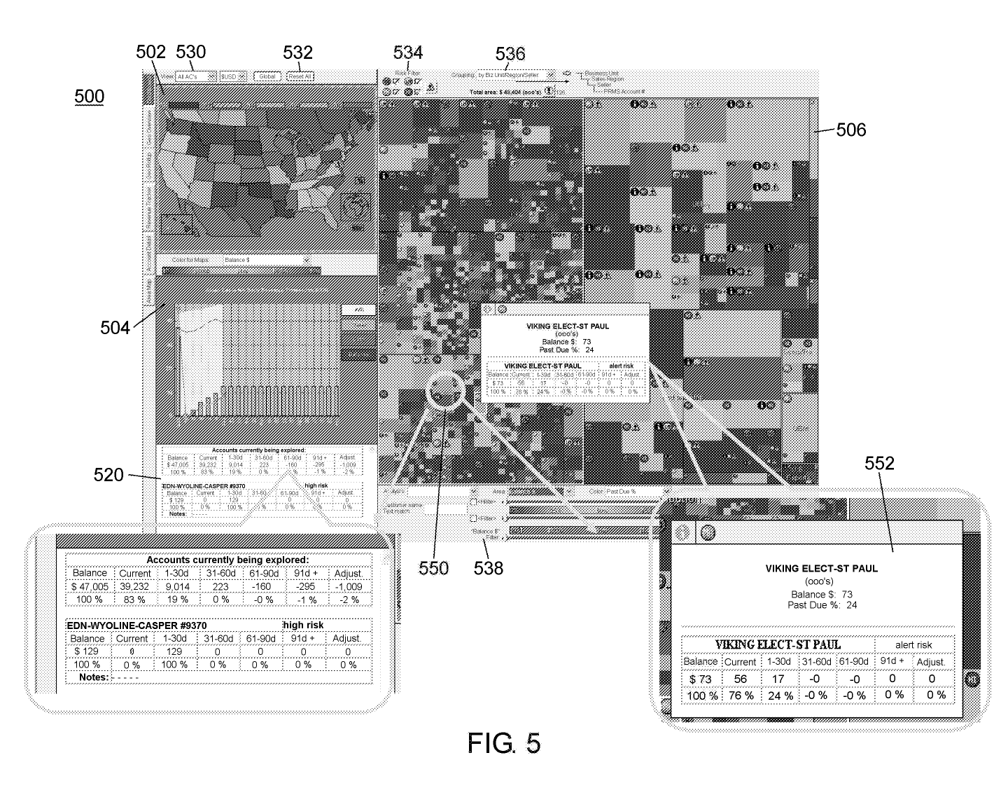

FIG. 5 is a third example of an IVD GUI 500, under an embodiment. The GUI 500 includes multiple display regions. The GUI 500 includes right brain representations 502-506 of data displayed in a first group or set of regions of the display. The GUI 500 also includes left brain representations 520 of data displayed in a second group or set of regions of the display. The left brain representations 520 are integrated into the same display or application as the right brain representations 502-506. The data supporting the right brain 502-506 and left brain 520 representations is the same data and is linked. The GUI 500 further includes a third group or set of regions of the display that include controls 530-538. The controls 530-538 provide varying types and combinations of control over the right brain 502-506 and left brain 520 representations.

The GUI 500 of this example includes a tree map 506 that shows multiple dimensions of information in a single “big picture”. The tree map 506 depicts detail items as a rectangle having size and color representing a different data attribute. For example, the size of each rectangle can represent dollar sales, units sold, or customer balances to name a few. The color of each rectangle can represent percentage variances, performance issues (for example, sales performance percentage growth versus budget or prior year), percentage of defects, percentage out of stocks, and percentage of receivables past due or other data attributes to name a few. Furthermore, each contour has one of a size and a location corresponding to a second attribute of the data. It is noted that different regions of the first group of display regions can present or include a different type and/or combination of contour.

This GUI 500 demonstrates functions of the IVD system and IVD that include a hyper-text window with “mouse over” capability. In this example, the location 550 of an indicator device (e.g., cursor) is detected on a contour of the tree map 506. In response to the detected location of the indicator device, a hyper-text window 552 is displayed over the tree map 506. The hyper-text window 552 includes or displays left brain or linear data corresponding to the right brain information represented by the contour. Additionally, the left-brain representation 520 can be linked to and display data corresponding to the contour over or near which the indicator is detected.

The GUI of an embodiment includes one or more controls linked to the data in such a manner as to provide a user the ability to navigate through the data or manipulate the right and left brain representations of the GUI, as described above. Regardless of type of control used, the controls provide control over selection of the data so that a selection made via the controls is reflected in the right and left brain representations of the GUI. For example, the controls can provide control over selection of dynamic queries of the data. In this example, some number or combination of controls can be used to select or filter information (e.g., past due amounts, past due percentages, balance in dollars, etc.) for analysis, display, report generation, and/or printing. These controls are again integrated into a single GUI or application along with the right brain and left brain representations of the data they control.

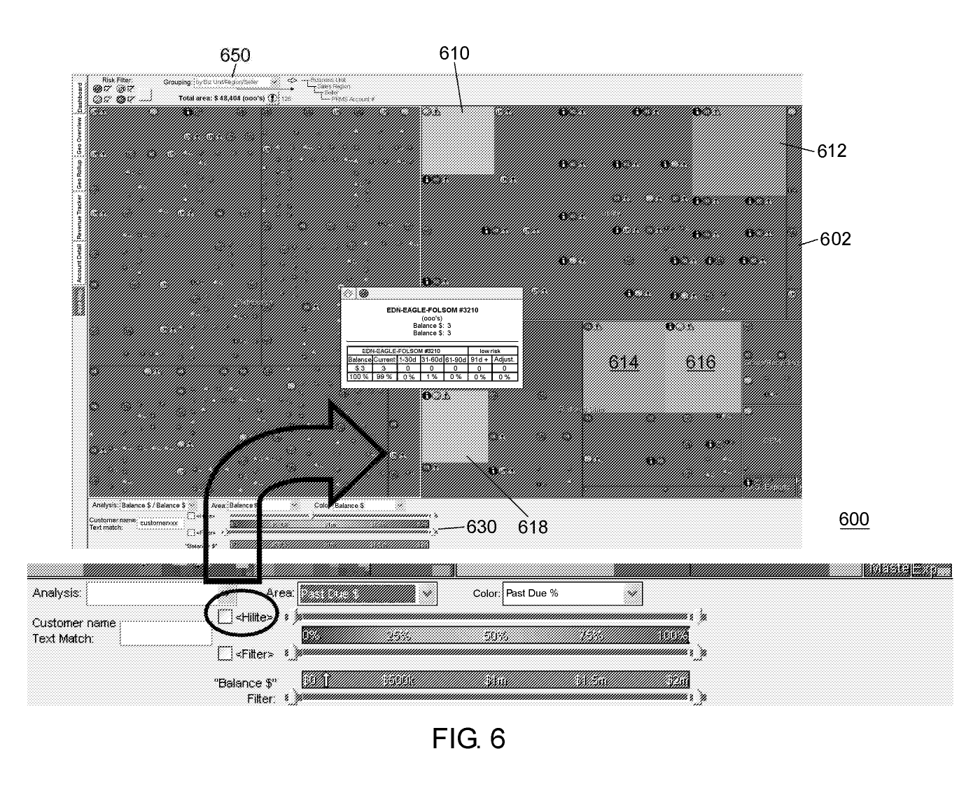

As another example, the controls can also provide control over selection of dynamic queries that highlight selected data entities of the data. FIG. 6 is a fourth example of at least portions of an IVD GUI 600, under an embodiment. The GUI 600 includes a right brain representation 602 (e.g., tree map) of data displayed in a group or set of regions of the display. The GUI 600 also includes another group or set of regions of the display that include controls 630. The controls 630 of this example include drop-down menus and sliders that provide varying types and combinations of control over the right brain 602 representations. The GUI 600 can include other types and combinations of representations as described and shown herein.

The GUI 600 of this example includes a tree map 602 that shows multiple dimensions of information in a single “big picture”. The tree map 602 depicts detail items as a rectangle having size and color representing a different data attribute. For example, the size of each rectangle can represent quantities related to a specific customer such as dollar sales, units sold, or customer balances to name a few. Each rectangle is grouped with others in a larger grouping that indicates a similarity such as type of sales item, type of customer, originating sales office, salesman responsible for the sale, or sales region to name just a few. The larger groupings are described/named in the tree map 602. The color of each rectangle can represent percentage variances, performance issues (for example, sales performance percentage growth vs. budget or prior year), percentage of defects, percentage out of stocks, and percentage of receivables past due or other data attributes to name a few. Furthermore, each contour has one of a size and a location corresponding to a second attribute of the data. It is noted that different regions of the first group of display regions can present or include a different type and/or combination of contour selected by the business category selector 650 such as business region, salesman, buyer group, corporate customer, product line, or credit manager to name just a few.

This example shows one possible result of dynamic query parameters selected via one of the controls 630, all information (contours) shown on the tree map 602 remains in size dimension, and the contours 610-618 that match the selection criteria are colored while contours not matching the selection criteria (all other contours except contours 610-618) are grayed out or in some other way indicated to be non-matching. For example, the parameter selected could be sales in excess of a specific dollar amount. All customers with sales less than that amount are grayed out and only those customers with sales above the selected parameter are shown in color (e.g., each item/customer's color being represented for example by its percentage of past due receivables balance). Using this selection parameter keeps each item/customer selected within the boundaries of its larger grouping so that the reviewer can see whether the items selected predominantly occur within for example the same region, sales category, or type of customer to name just a few.

A nuance to this selection parameter is to use a different selector that eliminates all those items that do not meet the section parameters (e.g. sales in excess of a specific amount) and shows on the screen 602 only those items that meet the section criterion. The reviewer has the selected items now filling the available screen ‘real estate’ which facilities quicker review and understanding.

Using a different parameter selector, for example, to select only those customers with past due balances in excess of 50% of the total receivables, will eliminate all items/customers which do not meet the 50% selection criterion from the screen 602. The GUI 602 will now be filled only with those customers which meet the 50% selection parameter so that the reviewer has the selected items now filling the available screen ‘real estate’ which facilities quicker review and understanding. The selected items are still grouped together in their larger business category grouping described above so that the reviewer can determine if there is a specific business category which is predominant in the selection results.

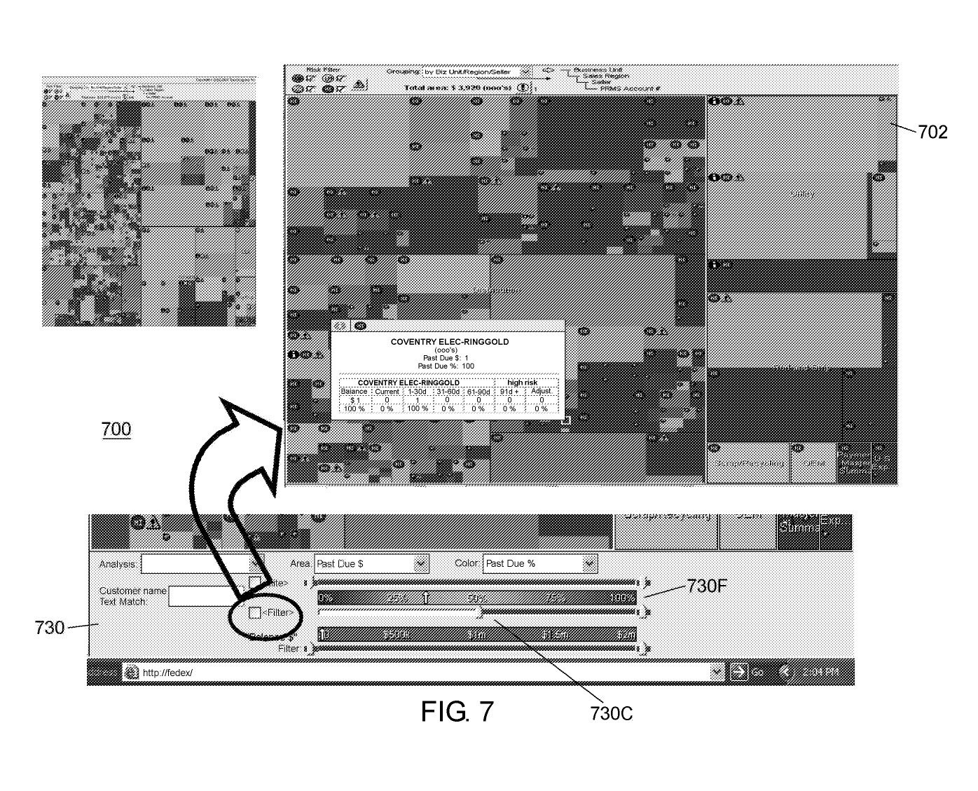

As yet another example, the controls can provide control over selection of dynamic queries that filter the data. FIG. 7 is a fifth example of select portions of an IVD GUI 700, under an embodiment. The GUI 700 includes a right brain representation 702 (e.g., tree map) of data displayed in a group or set of regions of the display. The GUI 700 also includes another group or set of regions of the display that include controls 730. The controls 730 of this example include drop-down menus and sliders that provide varying types and combinations of control over the right brain 702 representations as described below. The GUI 700 can include other types and combinations of representations as described and shown herein.

The GUI 700 of this example includes a tree map 702 that depicts detail items as a rectangle having size and color representing a different data attribute. In this example, the controls 730 are drop-down menus and sliders linked to dynamic queries that filter selected data to entities that match the selection criteria. For example, the drop-down controls 730 of this example are set so past due amounts control the contour (“area”) and past due percentages control the color of each contour. The result of the filtering applied with the slider 730F is that only filtered data entities are displayed on the tree map 702, so that the size of the contours is changed in relation to all other information (all other contours) on the tree map 702. In this example only accounts that match the filter criteria “50%” 730 C or more past due are displayed.

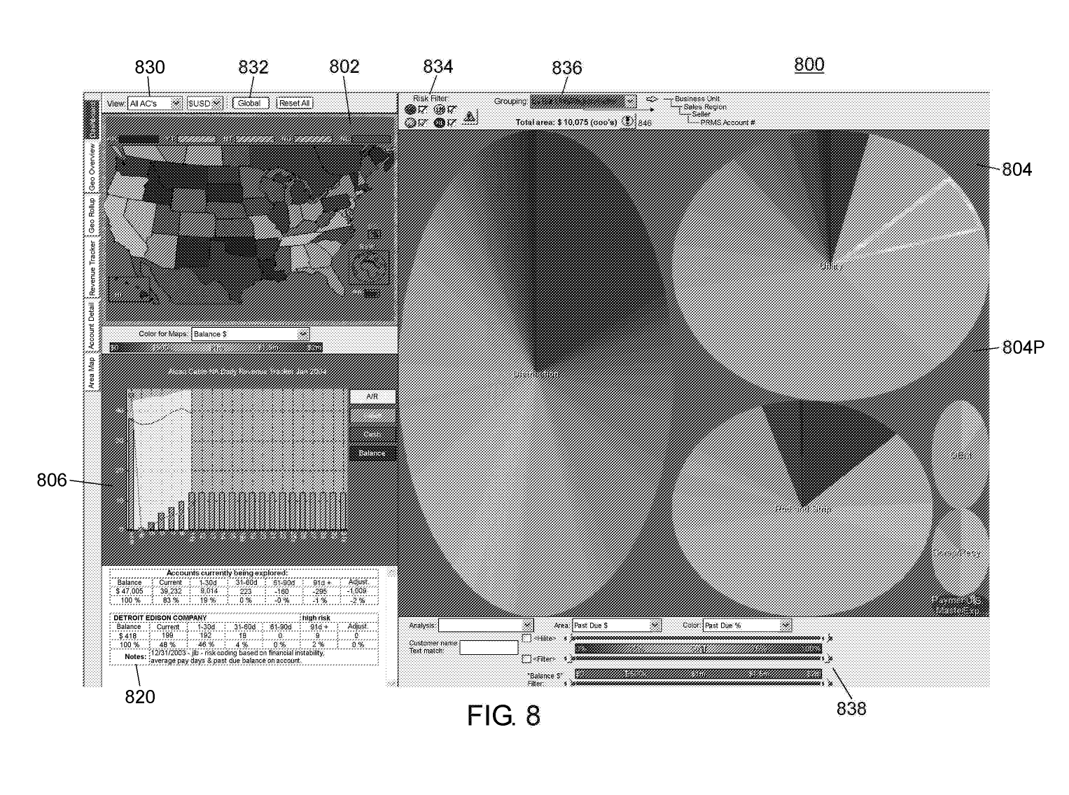

FIG. 8 is a sixth example of an IVD GUI 800, under an embodiment. The GUI 800 includes multiple display regions. The GUI 800 includes right brain representations 802-806 of data displayed in a first group or set of regions of the display. The GUI 800 also includes left brain representations 820 of data displayed in a second group or set of regions of the display. The left brain representations 820 are integrated into the same display or application as the right brain representations 802-806. The data supporting the right brain 802-806 and left brain 820 representations is the same data and is linked. The GUI 800 further includes a third group or set of regions of the display that include controls 830-838. The controls 830-838 provide varying types and combinations of control (e.g., time period reviewed, US currency, specific foreign currency, size of customer, etc.) over the right brain 802-806 and left brain 820 representations as described herein.

The right brain representations of this example GUI 800 include dynamic pie charts 804P that show multiple dimensions of information in a single “big picture”. While this example shows multiple pie charts 804P, alternative embodiments can show a single pie chart or a different number of pie charts than the number shown here. A pie chart 804P depicts detail items as pie slices, each of which has a size and color representing a different attribute of the data corresponding to the slice. For example, the size of each slice can represent dollar sales, units sold, or customer balances to name a few. The color of each slice can represent percentage variances, performance issues (for example sales performance percentage growth vs. budget or prior year), percentage defects, percentage out of stocks, or other data attributes, for example. Furthermore, each slice has one of a size and a location corresponding to a second attribute of the data. As with the tree map described above, selection of a pie slice causes the next lower level of data to be displayed on the GUI 800.

The right brain representations of various embodiments can include any type of representation using some combination of contours, size, and color to represent data attributes. For example, the right brain representations can include a sunburst chart, a stacked area pie chart, a radar chart, a dynamic pie chart, a scatter chart, and dynamic line chart to name a few.

The IVD of an embodiment links the right brain and left brain representations to account-related or attribute-related semantic information corresponding to the data of a selected representation. The semantic information can reside in an enterprise coupled to the data or can reside in a collocated database. The semantic information includes electronic documents and electronic mail messages, but is not so limited and can include other types of unstructured data or information.

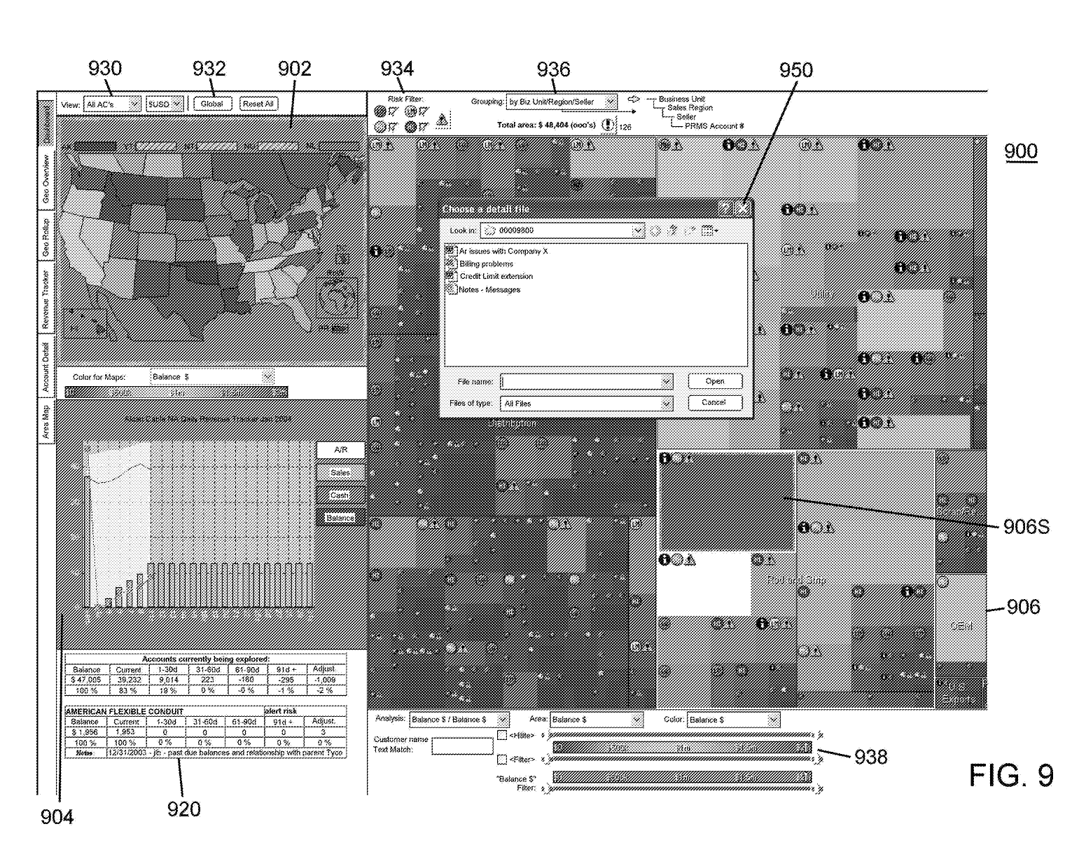

As an example, FIG. 9 is a seventh example of an IVD GUI 900, under an embodiment. The GUI 900 includes multiple display regions. The GUI 900 includes right brain representations 902-906 of data displayed in a first group or set of regions of the display. The right brain representations 902-906 of the GUI 900 include a tree map 906 that shows multiple dimensions of information in a single “big picture”. The tree map 906 depicts detail items as a rectangle having size and color each representing a different data attribute.

The GUI 900 also includes left brain representations 920 of data displayed in a second group or set of regions of the display. The left brain representations 920 are integrated into the same display or application as the right brain representations 902-906. The data supporting the right brain 902-906 and left brain 920 representations is the same data and is linked. The GUI 900 further includes a third group or set of regions of the display that include controls 930-938. The controls 930-938 provide varying types and combinations of control over the right brain 902-906 and left brain 920 representations.

In this example, a contour 906S is selected via the tree map 906. The IVD of an embodiment, which links the right brain and left brain representations to account-related or attribute-related semantic information corresponding to the data of a selected representation, displays a window 950 on the GUI 900 in response to the contour selection. The window 950 includes links to semantic data corresponding to the selected contour 906S and available in the host system or enterprise. The semantic information includes electronic documents and electronic mail messages, but is not so limited and can include other types of unstructured data or information. As one example, the semantic information can include links to all electronic documents and electronic mails found in the host system and relating to the data of the contour.

The IVD of an embodiment integrates predictive “what if” analysis with the right brain and left brain presentation, thereby linking the predictive analysis to the right brain and left brain presentations that provide data navigation functionality. The IVD therefore provides forward looking “what-if” predictive analysis capability based on prior actual retail sales data, for example, to estimate the impact on future sales values (units or dollars) of specific products based on changes in key business drivers such as the products retail sales price, equivalent competitor product retail sales price, and sales events such as in-store displays, weekend sales promotions, end aisle displays etc. This modeling functionality tool is based on the relationship of independent business drivers to key performance indicators.

The predictive method of an embodiment includes multiple regression analyses which can be linear or non-linear. The regression analyses will evaluate the relationship between the changes in the independent variables such as sales price, competitive sales price, new product and new package launches, in-store events such as promotional and end aisle displays, fast lane merchandisers, and temperatures, and use the result to predict the impact on future sales of one or more of these variables. Controls are provided via the IVD GUI to change the magnitude of a number of independent variables to predict the impact of future sales values from changes in these single or multiple sliders based on past historical data. The GUI controls of an embodiment include a selector for use in selecting and changing the regression method from linear to non-linear as desired.

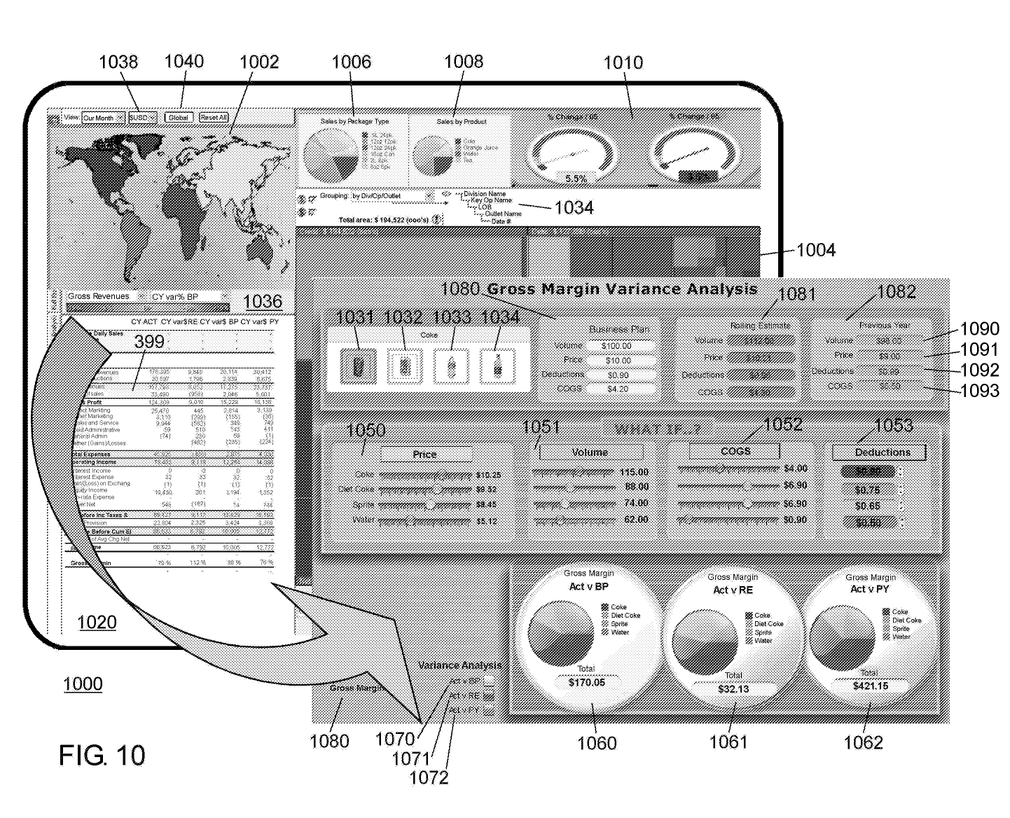

FIG. 10 is an eighth example of an IVD GUI 1000 for predictive analysis, under an embodiment. The GUI 1000, as described above, includes multiple display regions. The GUI 1000 includes right brain representations 1002-1010 of data displayed in a first group or set of regions of the display. The GUI 1000 also includes left brain representations 1020 of data displayed in a second group or set of regions of the display. The left brain representations 1020 are integrated into the same display or application as the right brain representations 1002-1010. The data supporting the right brain 1002-1010 and left brain 1020 representations is the same data and is linked. The GUI 1000 further includes a third group or set of regions of the display that include controls (not shown). The controls provide varying types and combinations of control over the right brain 1002-1010 and left brain 1020 representations, as described in detail herein.

The GUI 1000 integrates predictive “what if” analysis functionality with the right brain and left brain presentation through controls that allow a user to control variables. For example, once the user has drilled down to the lowest level of a finite business unit (i.e. not a summary level of two or more business units) the user can perform “what if” analyses on selected line items in the income statement. For example, the user could select from the gross margin line (see GUI 300, element 399 (FIG. 3)) and then perform “what if” analyses on multiple variables of different products. The user first selects a specific product item 1031-1034 for the “what if” analysis. The data related to this product, the three different time periods 1080-1082 (Business Plan (BP) Rolling Estimate (RE), and previous Year (PY), and the four possible component variables 1090-93 (volume of units sold, price of each unit, deductions related to sales such as freight, and cost of goods sold (COGS)) are shown as finite numbers (left brain) when the specific product icon is selected with the click of the mouse.

Predictive analyses can then be performed using or under control of sliders 1050-1053 for each specific product and for each of the component variables Price, Volume, COGS, and Deductions. For example, when the Price slider 1050 for Product 1 1031 is moved the impact of the projected increase or decrease in price is shown in both left brain and right brain terms. The impact of the projected price increase/decrease on the gross margin versus the Business Plan (BP), the Rolling Estimate (RE), and the Prior year (PY) 1060-1062 is shown as a finite number (left brain) with that specific product's new share of the total margin of all products shown (in right brain terms) as a color coded share of the pie chart related to the Gross Margin versus the Business Plan (BP), the Rolling Estimate (RE), and the Prior Year (PY). A similar analysis is realized when the sliders related to Volume, COGS, and Deductions 1051-1053 are moved to increase or decrease the relevant component variable.

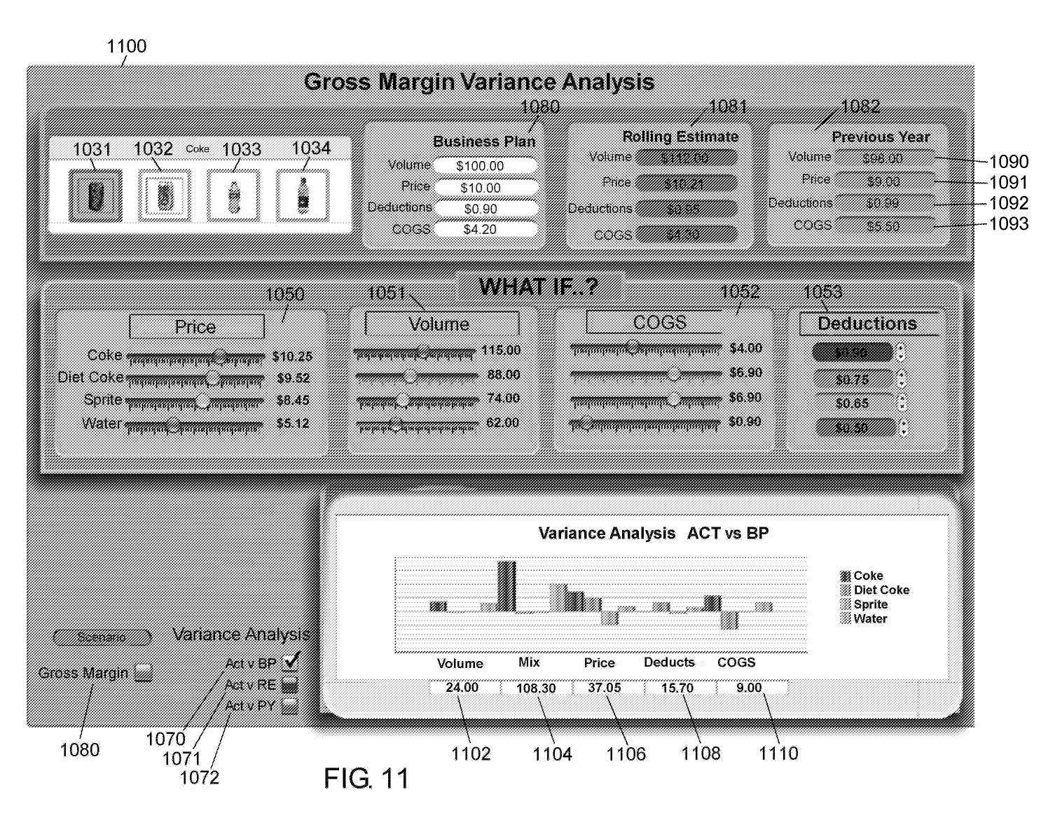

FIG. 11 is another example of an IVD GUI 1100 for predictive analysis, under an alternative embodiment. The right brain view provided in GUI 1100 shows the five components of the variance (Volume 1102, Mix 1104, Price 1106, Deductions 1108, and COGS 1110) color coded by product type. The projected gross margin variance versus the relevant time period base (e.g., business plan (BP), rolling estimate (RE), prior year (PY)), can be shown by the selection of the relevant Variance Analysis radio button 1070-1072. The variance component details 1102-1110 are shown, color coded by product, as vertical bars (right brain view) together with the net totals of the (four) products combined for each of the (five) components shown as (left brain) finite numbers below the vertical bars, but the embodiment is not so limited.

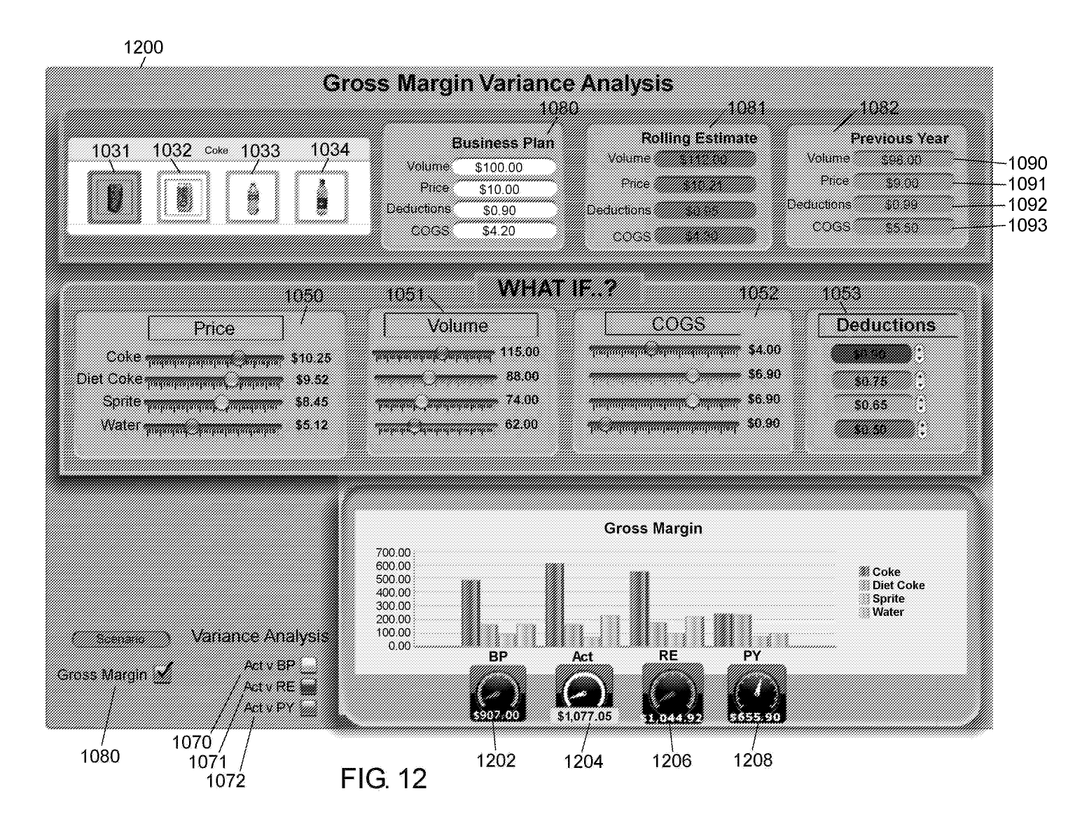

FIG. 12 is a further example of an IVD GUI 1200 for predictive analysis, under another alternative embodiment. The product component amounts of each of the gross margin time periods (e.g., business plan (BP) 1202, Actual/projected (Act) 1204, rolling estimate (RE) 1206, prior year (PY) 1208) is shown in this GUI 1200 using both left brain terms (an absolute amount total of all products shown inside a gauge) and right brain views (color coded product amounts) as vertical bar charts by the selection of the Gross Margin radio button 1080.

The IVD described herein can be used with any type of data or information. Some examples of the use of IVDs include, but are not limited to, physical asset management and utilization analysis, asset entity relationship and infrastructure analysis, threat management reporting and analysis, financial asset analysis with predictive capabilities, software license rationalization analysis, and change management monitoring. Two specific examples follow of use of the IVD in managing data, but the embodiments herein are not limited to these examples.

The IVD of an embodiment can include an accounts receivable application that provides multiple different views of a company's data from one GUI. The GUI of this example integrates components including, but not limited to, the following: a tree map (color coded two-dimensional squarified heat map) with risk filters and sliders to track $50 MM of receivables integrated with drilldown capability from summary data down to specific customers; line graphs; color-coded maps of the United States by State, where the color provides the viewer an indication of one aspect of the data (e.g., green is good, red is bad, etc.); controls to filter out data the user does not want to review (such as all good data) to allow him/her to focus only on the “bad” data; controls for use in selecting a subset of the data obtained as a result of the filtering and generating a left brain list or report of the filtered data to be sent to an associate for follow up.

The IVD of an embodiment can include a financial reporting application that combines multiple different views (components) on one GUI, including tabs for use in selecting and expanding any one specific view. The GUI of this example integrates components including, but not limited to, a series of gauges and graphs that show key business indicators (KBIs) such as revenue units, revenue dollars, gross margins, market share, performance by specific brand etc. A drop down box is also provided that allows the user to select one or more of the following parameters: current month amounts/numbers; year to date (YTD) amounts; current quarter; and YTD by quarter.

The GUI of this example integrates components including, but not limited to, color coded maps (e.g., United States maps by State, world maps by country, etc.) where the color gives the viewer an indication of one aspect of the data (e.g., green is good, red is bad, etc.). The maps include two drop down boxes that allow the user to change two sets of variables as selected by the user. For example the user can select all the line items in the income statement from revenue to net income and compare the selected line item against multiple different views of that data (e.g., current year actual YTD versus prior year actual YTD; current year actual YTD versus two years ago actual YTD; current year actual YTD versus current year budget YTD; current year actual YTD versus current year forecast YTD; current month full year forecast versus last months full year forecast; current month full year forecast versus full year budget; current month full year forecast versus prior year actual; etc.).

The GUI of this example integrates components including, but not limited to, a tree map of the income statement showing color coded debits and credits side-by-side with drill down capability together with controls (e.g., sliders). The tree map also provides for the user to change the tree map view from squares to other views such as pie charts, radar diagrams, scatter charts, etc. The controls on the tree maps allow the user to filter out data the user does not want to review (e.g., all “good” data) to allow him/her to focus only on the “bad” data.

The tree maps include two controls (e.g., drop down boxes) that allow the user to change two sets of variables. For example a first control allows the user to define the area of the square (and thus the magnitude of the amount) and can show various actual absolute numbers such as the following: current year actual (CYA); prior year actual (PYA); prior year 2 actual (PY2A); current year estimate (CRE); current year budget (CYB); etc. A second control defines the state of the data by its color (e.g., green is good, red is bad, etc.) and can show the data selected using the first control compared to various different user selected views such as the following: current year actual versus prior year actual variance percentage (CYA variance % PYA); current year actual versus current year budget variance percentage (CYA variance % PYA). The user can select all the line items in the income statement from revenue to net income using the first control and compare the selected line item against multiple different views of that data (e.g. CYA variance % PYA; CYA variance % PY; etc.).

The GUI of this example integrates components including, but not limited to, KPI gauges and dials. The GUI of this example integrates components including, but not limited to, color coded performance maps integrated with the tree map and KPI gauges.

The GUI of this example integrates components including, but not limited to, performance map and tree map data views that include an information icon that can be selected in order to provide or present a linked semantic file such as an email, or a Word document that provides additional reference information about that map state or tree map cell. The user can then respond by email to the sender of the email which will be “saved/filed” in the information icon for future reference by the user. This feature is thus an effective follow up tool for the user.

The GUI of this example integrates components including, but not limited to, standard income statements.

The GUI of this example integrates components including, but not limited to, all components described above in this example, the components linked and integrated so that as a user drills down all the various views (e.g., tree map, gauges, color coded maps, piechart/bar charts, income statement spreadsheet, etc.) stay aligned and show the same summary data (or drill down data) but in different left and right brain views/formats.

The GUI of this example integrates components including, but not limited to, predictive analysis capability from the drill down detail level in the income statement for use in predicting the impact on profit of varying one or more of the line items in the income statement.

The GUI of this example integrates components including, but not limited to, controls for use in selecting a subset of the data (obtained as a result of the control) and generating a left brained list or report of the filtered data to be sent to an associate for follow up.

The IVD system and IVD of an embodiment include a method of displaying data. The method of an embodiment includes generating a display page on an electronic display, the display page comprising display regions. The method of an embodiment includes displaying in a first plurality of the display regions a plurality of first representations of the data. Each of the first representations of an embodiment includes a plurality of contours. Each contour of an embodiment has a color corresponding to a first attribute and one of a size and a location corresponding to a second attribute of the data. The method of an embodiment includes displaying in a second plurality of the display regions a plurality of second representations of the data. Each of the second representations of an embodiment includes a linear representation selected from a group consisting of a spreadsheet, chart, matrix, plot, list, and semantic data. The plurality of second representations of an embodiment is linked to the plurality of first representations.

The method of an embodiment includes displaying in a third plurality of the display regions a first plurality of controls. The first plurality of controls of an embodiment provides control over selection of a level of the data. A selection made via the first plurality of controls of an embodiment is reflected in the plurality of first representations and the plurality of second representations.

The method of an embodiment includes displaying in a third plurality of the display regions a second plurality of controls. The second plurality of controls of an embodiment provides control over selection of a time period for the data. The time period of an embodiment is one of a historical time period and a future time period. A selection made via the second plurality of controls is reflected in the plurality of first representations and the plurality of second representations.

The method of an embodiment includes displaying in a third plurality of the display regions a third plurality of controls. The third plurality of controls of an embodiment provides control over selection of dynamic queries of the data. A selection made via the third plurality of controls of an embodiment is reflected in the plurality of first representations and the plurality of second representations.

The method of an embodiment includes displaying in a third plurality of the display regions a fourth plurality of controls. The fourth plurality of controls of an embodiment provides control over selection of dynamic queries that highlight selected data entities of the data. A selection made via the fourth plurality of controls of an embodiment is reflected in the plurality of first representations and the plurality of second representations.

The method of an embodiment includes displaying in a third plurality of the display regions a fifth plurality of controls. The fifth plurality of controls of an embodiment provides control over selection of dynamic queries that filter the data. A selection made via the fifth plurality of controls of an embodiment is reflected in the plurality of first representations and the plurality of second representations.

The method of an embodiment includes displaying in a fourth plurality of the display regions a sixth plurality of controls. The sixth plurality of controls of an embodiment provides control over selection of content, data type, graphic type, and data level. A selection made via the sixth plurality of controls of an embodiment is reflected in the plurality of first representations and the plurality of second representations.

The plurality of first representations of an embodiment is controls for navigation through a plurality of levels of the data.

The method of an embodiment includes displaying in a first region of the first plurality of display regions a subset of the data in response to selection of a portion of a first representation in a second region of the first plurality of display regions.

The method of an embodiment includes detecting location of an indicator device on a contour of the plurality of first representations. The method of an embodiment includes displaying a hyper-text window over the display page in response to the location. The hyper-text window of an embodiment includes one of semantic information and the second representation of the data corresponding to the contour.

The method of an embodiment includes linking the plurality of first representations to semantic information corresponding to the data. The semantic information of an embodiment resides in an enterprise coupled to the data. The semantic information of an embodiment includes electronic documents and electronic mail messages.

The data of an embodiment is physical asset data.

The data of an embodiment is financial data. The financial data of an embodiment is profit and loss data.

The IVD system and IVD of an embodiment include a graphical user interface (GUI). The GUI of an embodiment includes a display page on an electronic display. The display page of an embodiment comprises display regions. The GUI of an embodiment includes a plurality of first representations of data displayed in a first plurality of the display regions. Each of the first representations of an embodiment includes a plurality of contours. Each contour of an embodiment has a color corresponding to a first attribute and one of a size and a location corresponding to a second attribute of the data. The GUI of an embodiment includes a plurality of second representations of the data displayed in a second plurality of the display regions. Each of the second representations of an embodiment includes a linear representation selected from a group consisting of spreadsheets, charts, graphs, plots, and lists. The plurality of second representations of an embodiment is linked to the plurality of first representations.

The IVD system and IVD of an embodiment include a system for displaying a graphical user interface. The system of an embodiment includes a display device. The system of an embodiment includes a processor coupled to a database. The processor of an embodiment communicates with the database and the display and executes a display module. Execution of the display module of an embodiment generates a display page on the display device. The display page of an embodiment comprises display regions. Execution of the display module of an embodiment displays in a first plurality of the display regions a plurality of first representations of data. Each of the first representations of an embodiment includes a plurality of contours. Each contour of an embodiment has a color corresponding to a first attribute and one of a size and a location corresponding to a second attribute of the data. Execution of the display module of an embodiment displays in a second plurality of the display regions a plurality of second representations of the data. Each of the second representations of an embodiment includes a linear representation selected from a group consisting of spreadsheets, charts, graphs, plots, and lists. The plurality of second representations of an embodiment is linked to the plurality of first representations.

Aspects of the information visualization system or dashboard described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the information visualization system include: microcontrollers with memory (such as electronically erasable programmable read only memory (EEPROM)), embedded microprocessors, firmware, software, etc. Furthermore, aspects of the information visualization system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that components of the information visualization system disclosed herein may be described using computer aided design tools and/or expressed (or represented) as data and/or instructions embodied in various computer-readable media, in terms of their behavioral, functional, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described systems and methods may be processed by a processing entity (e.g., one or more processors) within the computer system in conjunction with execution of one or more other computer programs.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the information visualization system is not intended to be exhaustive or to limit the systems and methods to the precise form disclosed. While specific embodiments of, and examples for, the information visualization system are described herein for illustrative purposes, various equivalent modifications are possible within the scope of other systems and methods, as those skilled in the relevant art will recognize. The teachings of the information visualization system provided herein can be applied to other processing systems and methods, not only for the systems and methods described above.

The elements and acts of the various embodiments described above can be combined to provide further embodiments. These and other changes can be made to the information visualization system in light of the above detailed description.

In general, in the following claims, the terms used should not be construed to limit the information visualization system to the specific embodiments disclosed in the specification and the claims, but should be construed to include all systems that operate under the claims. Accordingly, the information visualization system is not limited by the disclosure, but instead the scope of the information visualization system is to be determined entirely by the claims.

While certain aspects of the information visualization system are presented below in certain claim forms, the inventors contemplate the various aspects of the information visualization system in any number of claim forms. Accordingly, the inventors reserve the right to add additional claims after filing the application to pursue such additional claim forms for other aspects of the information visualization system.

What is claimed is:

1. A method of displaying data, comprising:
generating a display page on an electronic display, the display page comprising display regions;
displaying in a first plurality of the display regions a plurality of first representations of the data, each of the first representations including a plurality of contours, each contour having a color corresponding to a first attribute and one of a size and a location corresponding to a second attribute of the data; and
displaying in a second plurality of the display regions a plurality of second representations of the data, each of the second representations including a linear representation selected from a group consisting of a spreadsheet, chart, matrix, plot, list, and semantic data, the plurality of second representations linked to the plurality of first representations.

2. The method of claim 1, comprising displaying in a third plurality of the display regions a first plurality of controls, wherein the first plurality of controls provide control over selection of a level of the data, wherein a selection made via the first plurality of controls is reflected in the plurality of first representations and the plurality of second representations.

3. The method of claim 1, comprising displaying in a third plurality of the display regions a second plurality of controls, wherein the second plurality of controls provide control over selection of a time period for the data, wherein the time period is one of a historical time period and a future time period, wherein a selection made via the second plurality of controls is reflected in the plurality of first representations and the plurality of second representations.

4. The method of claim 1, comprising displaying in a third plurality of the display regions a third plurality of controls, wherein the third plurality of controls provide control over selection of dynamic queries of the data, wherein a selection made via the third plurality of controls is reflected in the plurality of first representations and the plurality of second representations.

5. The method of claim 1, comprising displaying in a third plurality of the display regions a fourth plurality of controls, wherein the fourth plurality of controls provide control over selection of dynamic queries that highlight selected data entities of the data, wherein a selection made via the fourth plurality of controls is reflected in the plurality of first representations and the plurality of second representations.

6. The method of claim 1, comprising displaying in a third plurality of the display regions a fifth plurality of controls, wherein the fifth plurality of controls provide control over selection of dynamic queries that filter the data, wherein a selection made via the fifth plurality of controls is reflected in the plurality of first representations and the plurality of second representations.

7. The method of claim 1, comprising displaying in a fourth plurality of the display regions a sixth plurality of controls, wherein the sixth plurality of controls provide control over selection of content, data type, graphic type, and data level, wherein a selection made via the sixth plurality of controls is reflected in the plurality of first representations and the plurality of second representations.

8. The method of claim 1, wherein the plurality of first representations are controls for navigation through a plurality of levels of the data.

9. The method of claim 1, comprising displaying in a first region of the first plurality of display regions a subset of the data in response to selection of a portion of a first representation in a second region of the first plurality of display regions.

10. The method of claim 1, comprising:
detecting location of an indicator device on a contour of the plurality of first representations; and
displaying a hyper-text window over the display page in response to the location, wherein the hyper-text window includes one of semantic information and the second representation of the data corresponding to the contour.

11. The method of claim 1, comprising linking the plurality of first representations to semantic information corresponding to the data, wherein the semantic information resides in an enterprise coupled to the data, wherein the semantic information includes electronic documents and electronic mail messages.

12. The method of claim 1, wherein the data is physical asset data.

13. The method of claim 1, wherein the data is financial data.

14. The method of claim 13, wherein the financial data is profit and loss data.

15. A graphical user interface, comprising:
a display page on an electronic display, the display page comprising display regions;
a plurality of first representations of data displayed in a first plurality of the display regions, each of the first representations including a plurality of contours, each contour having a color corresponding to a first attribute and one of a size and a location corresponding to a second attribute of the data; and
a plurality of second representations of the data displayed in a second plurality of the display regions, each of the second representations including a linear representation selected from a group consisting of spreadsheets, charts, graphs, plots, and lists, the plurality of second representations linked to the plurality of first representations.

16. A system for displaying a graphical user interface, comprising:
a display device;
a processor coupled to a database, the processor communicating with the database and the display and executing a display module, execution of the display module generating a display page on the display device, the display page comprising display regions;
execution of the display module displaying in a first plurality of the display regions a plurality of first representations of data, each of the first representations including a plurality of contours, each contour having a color corresponding to a first attribute and one of a size and a location corresponding to a second attribute of the data; and
execution of the display module displaying in a second plurality of the display regions a plurality of second representations of the data, each of the second representations including a linear representation selected from a group consisting of spreadsheets, charts, graphs, plots, and lists, the plurality of second representations linked to the plurality of first representations.
